(19) United States
(12) Patent Application Publication
(10) Pub. No.: US 2014/0270335 A1
(43) Pub. Date: Sep. 18, 2014

(54) System and Method for Embedding and Retrieving Covert Data in Overt Media

(71) Applicant: Vor Data Systems, Inc., San Diego, CA (US)

(72) Inventor: Brons Larson, San Diego, CA (US)

(73) Assignee: Vor Data Systems, Inc., San Diego, CA (US)

(21) Appl. No.: 14/191,126

(22) Filed: Feb. 26, 2014

Related U.S. Application Data
(60) Provisional application No. 61/784,688, filed on Mar. 14, 2013.

(51) Int. Cl. G06T 1/00

(52) U.S. Cl. CPC G06T 1/0021
USPC 382/100

(57) ABSTRACT

A system and method for embedding and retrieving covert data in overt media. The covert data is imperceptibly embedded into overt media, such as an image, using techniques such as time domain and frequency domain embedding, to generate embedded media The embedded media may be decoded by capturing an image of the embedded media using a smartphone or the like, and then decoding the embedded media to obtain the covert data. The covert data may be used in standalone fashion, such as for authentication, or may be looked up in a database or the like to obtain additional information such as promotional and advertising information.

### CROSS-REFERENCE TO RELATED APPLICATION

This application is based upon and claims the benefit of priority from U.S. Provisional Application Ser. No. 61/784,688, filed on Mar. 14, 2013, the entire contents of which are incorporated herein by reference.

### BACKGROUND OF THE INVENTION

There are a number of applications in which it is desirable to hide the contents of a message in plain sight. In other words, embed the message or data so that it is invisible to the naked eye. Some reasons for doing this include: communicating covertly, adding an additional layer of security for authenticating a product, adding an addition layer of information for tracking a product, adding an addition layer of information for sales, marketing, and promotional reasons, and adding an additional layer of information for entertainment reasons.

In the case of product authentication and tracking, for example, technologies for plain sight authentication and tracking such as QR bar codes exist that make use of Commercial Off-The-Shelf (COTS) technology for printing and scanning. These COTS technologies for the purpose of this disclosure include standard printers and camera/scanners that are readily available in most commercial stores. While these technologies, such as QR bar codes, have some utility, customers complain about the aesthetics of the solution along with the extra space required for the code. Other technologies require specialized printers, inks, and scanners for the solution to work.

Another challenge of covert communication systems is that the message data changes as it propagates through the distribution channel as it moves from sender to receiver. For example, when media is posted on many Internet and social web sites, the media is compressed and altered outside of the control of the sender. By altering the media, the ability to successfully retrieve covert data from the overt media becomes a significant challenge. Similarly, when media embedded with covert data is printed and then imaged using a smartphone, for example, the image changes significantly as it changes from digital image, to printed image, to digital picture of the printed image. Because of these challenges, the ability to embed large quantities of information in media becomes a significant challenge not adequately addressed by current solutions.

### SUMMARY OF THE INVENTION

The present invention overcomes the need to use custom printers, inks, and scanners and uses standard COTS technology to allow covert data and messages to be imperceptibly embedded directly into any media (image, video, or sound) including product labels. This invention also overcomes transmission challenges by providing a number of methods that allow large amounts of data to be encoded within the overt media, transmitted over a “noisy” channel, and then accurately decoded.

As opposed to conventional technologies such as QR bar codes, in which each QR bar code is visually different and unattractive in appearance, the present invention permits multiple visually identical media items (i.e. product labels, t-shirts, tickets or any other media) to be individually encoded with invisible codes/data. Thus, each item appears exactly the same but is in fact encoded with a different code. Using standard COTS technology, such as smartphones, cameras, computers, tablets, etc., in conjunction with software incorporating the present invention, encoded images can be read and decoded. There is no need for specialized cameras or readers. In addition, the present invention may work “standalone”, i.e., without an Internet connection, and may also be used to provide additional information if an Internet connection is available.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a conceptual diagram showing an implementation of the present invention in which a ticket is embedded with a Covert Message for authentication purposes.

FIG. 2 is a conceptual diagram showing an implementation of the present invention in which a t-shirt is embedded with a Covert Message for advertising purposes.

FIG. 3 is a conceptual diagram showing an implementation of the present invention in which a video game is embedded with a Covert Message.

FIG. 4 is conceptual diagram showing implementations of the present invention in which electronic and traditional billboards are embedded with Covert Messages.

FIG. 5 is a conceptual diagram showing an implementation of the present invention in which a ticket is embedded with a Covert Message for promotional purposes.

FIG. 6 is a conceptual diagram showing an implementation of the present invention in which an image is an embedded with another image.

FIG. 7 is a conceptual diagram showing an implementation of the present invention in which a Covert Message embedded in a t-shirt is used to obtain additional display content via the Internet.

FIG. 8 is a flowchart illustrating how a Covert Message can be used according to the present invention to add authentication or a tracking tag during the manufacturing process.

FIG. 9 is a flowchart illustrating how to read a Covert authentication/tracking code according to the present invention from a package containing a label with Embedded Media.

FIG. 10 is a generalized flowchart of an end-to-end system or path for transmitting and receiving Covert Messages according to the present invention.

FIG. 11 is a flowchart illustrating the steps of an implementation of the present invention in which a Covert Message is sent via social media.

FIG. 12 is a flowchart illustrating the steps of an implementation of the present invention in which a Covert Message is sent via a standard web site.

FIG. 13 is a flowchart illustrating the steps of an implementation of the present invention in which a Covert Message is sent via email.

FIG. 14 is a flowchart illustrating the steps of an implementation of the present invention in which a Covert Message is sent via the Internet and received using a specialized browser customized to detect Covert Messages.

FIG. 15 is a flowchart illustrating the steps of an implementation of the present invention in which a Covert Message is sent and received via a computer or smartphone custom app.

FIG. 16 is a flowchart illustrating the steps of an implementation of the present invention in which a Covert Message is sent and received via a game.

FIG. 17 is a flowchart illustrating the steps of an implementation of the present invention in which a Covert Message is sent and received via printed media.

FIG. 18 is a flowchart illustrating the steps of an implementation of the present invention in which a Covert Message is sent and received via electronic media.

FIG. 19 is a flowchart illustrating the steps of an implementation of the present invention in which a received and decoded Covert Message is looked up to obtain further content.

FIG. 20 is a flowchart illustrating the steps involved in reading Embedded Media from Printed or Electronic Media using a standard Capture Device according to the present invention.

FIG. 21 is a flowchart illustrating steps in retrieving additional content associated with a Covert Message from the Internet or a Database according to the present invention.

FIG. 22 is a flowchart illustrating steps for extracting and storing features and descriptors from known Overt Media according to the present invention.

FIG. 23 is a flowchart illustrating the steps involved in decoding a Covert Message from known Overt Media according to the present invention.

FIG. 24 is a flowchart illustrating the steps involved in decoding a Covert Message from Overt Media that is not known according to the present invention.

FIG. 25 is a flowchart illustrating exemplary steps that can be used to prepare a captured image for decoding according to the present invention.

FIG. 26 is a flow chart illustrating steps for embedding Covert Data in Overt Media using frequency domain encoding.

FIG. 27 is a flow chart illustrating steps for extracting Covert Data from Embedded Media using frequency domain encoding.

FIG. 28 is a flow chart illustrating steps for generating and encoding Covert Metadata.

FIG. 29 is a flow chart illustrating steps for decoding Covert Metadata.

### DETAILED DESCRIPTION OF THE INVENTION

### Definitions

The following terms are used throughout this specification in the description of the present invention and, when used, have meanings as set forth in the following definitions.

Overt Media: the media that is the carrier of the Covert Message or Data. The Overt Media may be any type of media or file format including, without limitation, image, video, sound, office productivity files such as powerpoint, etc.

Covert Message/Data: the message or data that is embedded in the Overt Media. The Covert Message/Data may be, without limitation, a text message, numeric message, image, video, sound or other media, etc.

Embedded Media: the Overt Media embedded with a Covert Message/Data.

Feature Detector: extracts the features of the media. The Feature Detector may be any type of detector including, without limitation, Brisk, Star, Sift, Surf, Orb, MSER, GFTT, Harris, Simple blob, Dense, Grid adapted, Pyramid adapted, Dynamic adapted, etc.

Descriptor Extractor: extracts the descriptor from the media based on the feature detector output. The Descriptor Extractor may be any type of extractor including, without limitation, Brisk, Sift, Orb, Brief, Freak, Calonder, Opponent color, etc.

Matcher: attempts to match a set of descriptors and returns the transformation between two media if a match is made. The Matcher may be any type of matcher including, without limitation, Hamming, Flann, knn, Radius, Brute force, L1, SL2, etc.

Database: used to store and retrieve information. The Database may be any type of database including, without limitation, file based, relational database, SQL, online storage, stream, queue, stack, in memory, etc.

Capture Device: a device used to capture an image from the real world. The Capture Device may be, without limitation, smartphones, cameras, scanners, video recorders, video conferencing equipment, sound records, web cams, augmented reality systems, etc.

Covert Metadata: information that tells the system how the covert message has been encoded into the media. Metadata can be stored in a Database or in software, or may be embedded in the media itself using a predetermined known algorithm.

Distribution Medium: the medium where the Embedded Media resides or is printed on. The Distribution Medium may be any type of printed or electronic media including, without limitation, paper, magazine ads, t-shirts, clothing, tickets, signs, posters, murals, billboards, television, video games, general websites, social websites such as Facebook, Pinterest and Twitter, tattoos, material, clothing, textiles, catalogs, coupons, Groupons, siding materials, window tint, construction materials, labels, stickers, decals, plastics, manufacturing materials, logos, bar codes, QR barcodes, other authentication/tracking media, custom paint, radar signal, holography, any electronically transmitted digital signal, etc.

Channel: the end-to-end path through which the Embedded Media flows, including the Distribution Medium. In the case of printed material, for example, this may include the printer, Distribution Medium, and Capture Device. In the case of distribution via social media, for example, the channel is primarily the social media being used such as Facebook.

Customer Application: the customer application software that interfaces with the encode/decode system of the present invention.

Compress/Decompress Data: a variety of data compression methods used to compress the Covert Message/Data. Reduction of the overall size of the data may be required based on the application. A large variety of data compress algorithms, software APIs, and tools may be used to perform this function. Arithmetic compression methods perform well. Such methods include, without limitation, WinRK, PPM, Winzip, Smaz, MSzip, 7-zip, gzip, zip, rar, Iha, etc.

Encrypt/Decrypt Data: a variety of encryption methods used to protect the Covert Message/Data so that it cannot be easily viewed unless the correct decryption keys exist. A large variety of encryption algorithms, software APIs, and tools are available to perform this function including, without limitation, NSA encryption, AES, Blowfish, DES, Triple DES, Serpent, Twofish, etc.

Encode/Decode Data: a variety of methods used to encode the Covert Message/Data for transmission robustness. These methods include, without limitation, Hamming, Golay, and BCH, etc.

Interleave/De-interleave Data: A variety of methods used to interleave the Covert Message/Data for added transmission robustness. These methods include, without limitation, rectangular, convolutional, random, S-random, QPP, etc.

Embed Message: a variety of methods used to embed the Covert Message/Data into the Overt Media. These methods are described below in detail in the Embedding Overview section.

Overview of Invention

The present invention provides a system and method for embedding and retrieving Covert Messages in Overt Media. The present invention provides a low cost solution using COTS technology. In many implementations, the system can be implemented merely using a smartphone with no special paper, no special inks, no special printers, no special hardware, no custom reader, and no Internet access (though Internet access is optional in some implementations).

The capabilities of the present invention are limitless, and include, without limitation, authentication of tickets/products/labels; marketing of merchandise with easy point-and-click purchase options; interactive promotion of events; and the capability to embed large amounts of data, such as an image within an image. FIGS. 1-7 are conceptual diagrams that provide a general introduction and overview of the invention.

FIG. 1 is a conceptual diagram generally showing one implementation of the present invention in which a product is authenticated. In the specific example of FIG. 1, a ticket 10 (the Distribution Medium) has printed thereon an Embedded Media. The Embedded Media includes an Overt Media (a Disneyland image in this example) in which a Covert Message is embedded. The Covert Message may be, for example, a code that is invisible to the human eye. In other words, to the observer, ticket 10 does not appear altered in any fashion and is indistinguishable from any other similar ticket. Various methods, described in more detail below, are provided by the present invention to imperceptibly encode a Covert Message into Overt Media. A Capture Device 12 such as a smartphone is used to scan and acquire an image from ticket 10 including the Embedded Media. The Embedded Media is then decoded using the process described below to generate the Covert Message. In the example of FIG. 1, the decoded Covert Message may be used to generate a display 13 on smartphone 12 indicating whether the ticket is authentic (or counterfeit). Or, as shown in FIG. 5, the decoded Covert Message in ticket 10 may be used to generate a display 13 on smartphone 12 that includes promotional information.

FIG. 1 is merely one example. The technology of the present invention can be used to embed data into virtually any product, including, without limitation, labels, packaging, direct to materials/textiles, etc. FIG. 2 is a conceptual diagram showing another example in which the image (Overt Media) on a t-shirt 23 (Distribution Medium) is embedded with a Covert Message. In this case, the Covert Message is associated with product information for t-shirt 23. Thus, when an image on t-shirt 23 including the Embedded Media is scanned and acquired by smartphone 12, it is decoded to generate the Covert Message or Code, which is then used to retrieve advertising/product information 24 that is displayed on the user's smartphone 12. This particular implementation of the present invention of retrieving additional content from the Internet or a Database that is associated with a Covert Message that is obtained from a captured image is described in more detail below with reference to FIG. 21.

FIG. 3 is a conceptual diagram of an implementation of the present invention in which a Covert Message is sent and received via a video game. In the particular example of FIG. 3, a Covert Message is embedded within a billboard 35 appearing within an image 30 in the video game. The specific implementation of use of a video game to send and receive Covert Messages is described in more detail below with reference to FIG. 16. Similarly, as shown in FIG. 4, covert messages may be sent and received within electronic and traditional media, such as electronic billboards 46 and traditional billboards 47. Further details of these implementations of the invention are provided herein with reference to FIGS. 17 and 18.

The present invention further provides the ability to embed large quantities of data, such as an image within an image. A conceptual diagram of such an implementation of the invention is illustrated in FIG. 6. As shown in FIG. 6, an original image (Overt Media) 60 of a beach scene is embedded with bits representing an image (map) 61 (Covert Message). The resultant Embedded Media 62 (image 60 with bits representing map 61 embedded therein) is visually identical to original Overt Media 60. In other words, the image with the map data embedded therein is visually identical to the original image without map data.

FIG. 7 is a conceptual diagram showing how embedded codes extracted according to the present invention may be used to obtain additional information associated with those codes when an Internet option is provided. For example, as previously described, a smart phone 12 is used to acquire an image included Embedded Media from t-shirt 23, which is then decoded to generate a Covert Code. In the example of FIG. 7, the Covert Code is “AFE7S”. The Covert Code is sent via the Internet to server 70, which looks up the Covert Code and obtains additional information, such as advertising or promotional information, which is then returned to and displayed on smart phone 12.

A general overview and introduction to the invention having now been provided, a more detailed description of the invention is set forth below with reference to FIGS. 8-29.

Embedding Overview

Multiple approaches may be used in accordance with the present invention to embed Covert Messages into Overt Media such that the Embedded Media is visually identical to the original Overt Media. Two examples—Time Domain Embedding and Frequency Domain Embedding—are described below.

Time Domain Embedding

Message bits are directly embedded into time domain data by, for example, changing the values of low or higher order bits. The algorithm for selecting the bits to alter can be a known seeded random function, predetermined bit “hopping”, or bit selection based on the encoded data itself, chosen using the higher or lower frequency content of the overt media, or chosen by the color composition of the image, structure of the image. Message bits can be embedded in any color plane including the transparency layer, and can be embedded in a metadata layer. The Overt Media can be converted to different color formats (ex CMYK, RGB, CYI, etc), and the Covert Data then embedded into that color format media. Similarly, the Overt Media can be converted to different sound and video formats, and the Covert Data then embedded into that sound/video format media.

Other techniques for embedding the message may be used such as altering the placement of pixels on printed materials and altering the placement on electronic materials using, for example, a custom media viewer. A printed material with dithered pixels could also be scanned and turned into an electronic file that could then be viewed using standard media viewing tools.

Frequency Domain Embedding

The message can also be encoded in the frequency domain using a variety of techniques. The Overt Media may be converted to the frequency domain using numerous techniques, such as converting the entire media file, single or multiple parts of the media file, or combinations of these. Transforms can include Fourier, cosine, sine, wavelet, wavelet packets, LFT, LCT, LST, brushlets, CBLTT, etc. In some cases a metric is needed to determine the best basis. Some of these metrics include, without limitation, sparsity, statistical independence, kurtosis. The Covert Data is then embedded into the Overt Media frequency coefficients. The Covert Data can be embedded in low order or high order bits. Selection of the location for embedding can be based on the scale of the basis functions, or frequency, or a combination. Some techniques for selecting coefficients for encoding Covert Data include, without limitation, sorting coefficients by magnitude and selecting a block of coefficients from the sorted list, selecting a block of coefficients directly from the unsorted Fourier “image”, selecting coefficients in a pre-seeded random method, any predetermined selection of coefficients, etc. FIGS. 26 and 27 provide a detailed example of the steps used in embedding Covert Data in Overt Media using frequency domain encoding, and extracting Covert Data from Embedded Media using frequency domain encoding.

Optimal performance depends on the application and Channel. Depending on the application or Channel in which the Embedded Media is transmitted, tradeoffs are made to optimize for size of Overt Media, size of Covert Data, robustness against Channel degradation (printed versus electronic, can include compression and degradation of the image that is outside of the control of the users), and the covertness itself (encryption, compression, visual and statistical analysis).

Other Types of Embedding

The invention is not limited to just time and frequency methods of embedding data. There are other ways in which Covert Data can be embedded in Overt Media. For example, without limitation, Beamlets can be used as a way to represent the Overt Media prior to encoding Covert Data. Similarly, other types of representations and transformations can be used.

Optimizing Encoding Based on Application

Depending on the Application, Overt Media used, Covert Data to be embedded, and Channel the best encoding method is selected. In some applications the Embedded Media should be easy to print and copy, however, in other cases it may be desirable that the Covert Data be rendered unrecoverable should it be copied with an undesirable Capture Device, but remain intact using the desired Capture Device. The embedding process and parameters are determined based on the application and can be generated manually, automatically, or by using an application with user assistance.

Covert Metadata Overview

Covert Metadata is a block of data that describes how the Covert Data is encoded in the Overt Media. The Covert Metadata can be known ahead of time, or can be transmitted in the Embedded Media. In the case where it is transmitted in the Embedded Media, a default Initial Covert Metadata is decoded and allows access to a second tier of Covert Data. Initial Covert Metadata can be in a single known format, or could be stored in a number of possible different formats that would need to be tested to determine the format of the Initial Covert Metadata.

Covert Metadata can encode multiple types of information including, without limitation, the type of embedding used, time domain versus frequency domain, the type of transformation used, where the data is stored, the preparation steps used, interleaving, encoding, encryption, and compression methods used, parameters used for different steps, as well as any additional information that would be beneficial to include.

The use of Covert Metadata is beneficial in that it allows a wide range of techniques to be used to optimize for the application and Channel. In addition, knowledge of what methods are being used is deferred until the moment that the Embedded Message is received. This allows for maximum system flexibility. An implementation of the present invention utilizing Covert Metadata is described in more detail below with reference to FIG. 24. In addition, FIGS. 28 and 29 show steps involved in generating and encoding Covert Metadata, and in decoding Covert Metadata.

Creation of an Authentication/Tracking Taq

FIG. 8 is a flowchart illustrating how a Covert Message can be used to add authentication or a tracking tag during the manufacturing process. In step 80, the Overt Media, such as a package label, is loaded into the system, and in step 81, the Covert Data, such as an authentication/tracking code, is loaded into the system. In some applications, it may be necessary to use a different authentication/tracking code for each label printed. In step 82, the Covert Data is embedded into the Overt Media (i.e., the authentication/tracking code is embedded into the package label). The embedding process of step 82 is described in more detail in transmit block 101 of FIG. 10, as well as in FIG. 26. A Distribution Medium, such as a physical packaging label, is provided in step 83, and in step 84, the Embedded Media (label with authentication/tracking code embedded therein) is printed or applied onto the Distribution Medium (physical packaging label). In step 85, the Distribution Medium is distributed with the Covert Message (authentication/tracking code) embedded therein.

Reading the Authentication/Tracking Taq

FIG. 9 is a flowchart illustrating how to read a Covert authentication/tracking code from a package containing a label with Embedded Media. The package containing a label with Embedded Media may have been generated, for example, using the process of FIG. 8. The Embedded Media may reside on any physical Distribution Medium. In step 90, an image of the Embedded Media is acquired using a Capture Device. The process of step 90 of acquiring an image of the Embedded Media using a Capture Device is illustrated in more detail in FIG. 20. In step 91, the message is decoded to produce the Covert Data 92. The decoding process of step 91 is described in more detail in receive block 107 of FIG. 10, as well as in FIG. 27. In step 93, the code is authenticated or, if the particular application requires a lookup of the code in a database, the code is looked up in database 94. Additional details of the lookup option are provided below with reference to FIGS. 19 and 21. In step 95, the code is used directly and interfaced with the Customer Application software or, if lookup in database 94 was required, the data returned from database 94 is interfaced with the Customer Application software.

End-to-End System for Transmitting and Receiving Covert Messages

FIG. 10 is a generalized flowchart of an end-to-end system or path 100 for transmitting and receiving covert messages. System 100 includes two primary components: a transmit block 101 for transmitting covert messages, and a receive block 107 for receiving covert messages. The steps of transmit block 101 may be used, for example, within the process of creating an authentication/tracking tag of FIG. 8 (i.e. step 82), and the steps of receive block 107 may be used, for example, within the process of reading an authentication/tracking tag of FIG. 9 (i.e. step 91).

Transmission of a Covert Message, as described in Transmit block 101 has three main steps: preparation of the Covert Message so that it can be embedded (step 103); embedding the Covert Message in the Overt Media (step 105); and sending/uploading the Embedded Media or printing/applying the Embedded Media (step 106). These steps are described in detail as follows.

Step 103 of Transmit block 101 involves preparation of a Covert Message 102 so that it can be embedded. The Covert Message will need to go through a number of steps to prepare the data. The steps required depends on the particular end use application. In the example shown in FIG. 10, the steps in preparation step 103 include: Compress Data; Encrypt Data; Encode Data; and Interleave Data. In one implementation, the data was compressed using WinRK, encrypted using NSA level encryption, encoded using BCH and interleaved using rectangular interleaving.

Step 105 of Transmit block 101 embeds the prepared Covert Message in Overt Media 104 to generate Embedded Media. One of the techniques described above in the Embedding Overview section, for example, may be used in step 105 to encode the Covert Data in the Overt Media. In one implementation, frequency domain encoding using Fourier transforms on the entire image was used. Data was embedded in low order bits of Fourier basis functions. FIG. 26 contains additional details regarding methods for encoding.

Step 106 of Transmit block 101 sends/uploads the Embedded Media produced in step 105, or prints/applies the Embedded Media onto a Distribution Medium. Examples of sending/uploading the Embedded Media include, without limitation, posting the Embedded Media on Facebook or emailing the Embedded Media to another person. Examples of printing/applying the Embedded Media include, without limitation, printing the Embedded Media on a ticket, t-shirt or a poster.

Reception of a Covert Message, as described in Receive block 107 is essentially the reverse of the steps of Transmit block 101 and involves three main steps: receiving/downloading or acquiring the Embedded Media (step 108); Extract the Covert Message from the Overt Media (step 110); and prepare the Covert Message so that it can be read (step 111). These steps are described in detail as follows.

Step 108 of Receive block 107 receives/downloads the Embedded Media or acquires a Distribution Medium including the Embedded Media. The Embedded Media is received in different ways depending on the application. Examples of receiving/downloading the Embedded Media include, without limitation, downloading the Embedded media from Facebook or receiving the Embedded Media via email. Examples of acquiring a Distribution Medium including the Embedded Media include, without limitation, imaging the Embedded Media using a smartphone from a ticket, from a t-shirt, or from a poster.

Step 110 of Receive block 107 extracts/decodes the Covert Message from the Overt Media. One of the techniques described above in the Embedding Overview section, for example, may be used to decode/extract the Covert Data from the Overt Media. In one implementation, frequency domain decoding using a Fourier transform on the entire image was used, and data was extracted from the low order bits of Fourier coefficients. FIG. 27 contains additional details regarding methods for extracting/decoding the Covert Message.

Step 111 of Receive block 107 prepares the Covert Message 112 so that it can be read. Once the Covert Message has been extracted, it must undergo a few more steps so that it can be read. The steps required depend on the steps that were used in step 103 of Transmit block 101 to prepare the message for embedding. In the example shown in FIG. 10, the steps in preparation step 111 include: De-interleave Data using rectangular de-interleaving; Decode Data using BCH; Decrypt Data using NSA level encryption; and Decompress Data using WinRK.

As shown in FIG. 10, step 106 of Transmit block 101 and step 108 of Receive block 107 define Channel 109 through which the Embedded Media flows. As the Embedded Media flows through Channel 109, it is degraded in a variety of ways depending on the application. For example, in the case of printed material, this includes degradation caused by the printer, Distribution Medium and Capture Device. In the case of distribution by sending or uploading, degradation may be caused, for example, by the compression requirements of the social media or email system. Depending on the particular application the correct Message Preparation and Message Encoding methods are selected.

Social Media Implementation

FIG. 11 illustrates the steps of an implementation of the present invention in which a Covert Message is sent via social media. In step 115, a Covert Message is embedded into Overt Media to generate Embedded Media (e.g. steps 102-105 of FIG. 10). In step 116, the sender uploads the Embedded Media to a social media site such as Facebook (e.g. step 106 of FIG. 10). In step 117, the receiver downloads the Embedded Media from the social media site (step 108 of FIG. 10). In step 118, the Covert Message is decoded from the Embedded Media (steps 110-112 of FIG. 10).

General Web Implementation

FIG. 12 illustrates the steps of an implementation of the present invention in which a Covert Message is sent via a standard web site. In step 125, a Covert Message is embedded into Overt Media to generate Embedded Media (e.g. steps 102-105 of FIG. 10). In step 126, the sender uploads the Embedded Media to a web site (e.g. step 106 of FIG. 10). In step 127, the receiver downloads the Embedded Media from the web site (step 108 of FIG. 10). In step 128, the Covert Message is decoded from the Embedded Media (steps 110-112 of FIG. 10).

Email Implementation

FIG. 13 illustrates the steps of an implementation of the present invention in which a Covert Message is sent via email. In step 135, a Covert Message is embedded into Overt Media to generate Embedded Media (e.g. steps 102-105 of FIG. 10). In step 136, the sender sends the Embedded Media to a receiver as an attachment to an email message (e.g. step 106 of FIG. 10). In step 137, the receiver receives the Embedded Media as an attachment to an email (step 108 of FIG. 10). In step 138, the Covert Message is decoded from the Embedded Media (steps 110-112 of FIG. 10).

Custom Browser Implementation

FIG. 14 illustrates the steps of an implementation of the present invention in which a Covert Message is sent via the Internet and received using a specialized browser customized to detect Covert Messages. In step 145, a Covert Message is embedded into Overt Media to generate Embedded Media (e.g. steps 102-105 of FIG. 10). In step 146, the sender posts the Embedded Media to a social media or other web site (e.g. step 106 of FIG. 10). In step 147, the receiver uses a custom browser application, or browser with a custom plug-in that checks all media on a social media or other web site for the presence of a covert message. The custom browser application may be manually operated by a user or an automated bot that searches without or with limited user interaction. Further, if media is found that has Covert Message(s) and the user is authenticated to view the Covert Message(s), a list of Covert Messages may be presented to the user, or the media may be tagged in a way to identify it as containing a Covert Message, or the list of media with Covert Messages may be stored in a Database for later use. (step 108 of FIG. 10). In step 148, the Covert Message is decoded from the Embedded Media (steps 110-112 of FIG. 10).

Custom App Implementation

FIG. 15 illustrates the steps of an implementation of the present invention in which a Covert Message is sent and received via a computer or smartphone custom app. In step 155, a Covert Message is embedded into Overt Media to generate Embedded Media (e.g. steps 102-105 of FIG. 10). In step 156, the sender sends the Embedded Media to a receiver via a customized computer or smartphone app (e.g. step 106 of FIG. 10). In step 157, the receiver receives the Embedded Media via a customized computer or smartphone app (step 108 of FIG. 10). In step 158, the Covert Message is decoded from the Embedded Media (steps 110-112 of FIG. 10).

Game Implementation

FIG. 16 illustrates the steps of an implementation of the present invention in which a Covert Message is sent and received via a game. In step 165, a Covert Message is embedded into Overt Media to generate Embedded Media (e.g. steps 102-105 of FIG. 10). In step 166, the sender embeds the Embedded Media into the game, for example, as an image or texture map (e.g. step 106 of FIG. 10). In step 167, the receiver uses custom software to image the Embedded Media or uses a Capture Device to image the screen on which the Embedded Media is displayed (step 108 of FIG. 10). In step 168, the Covert Message is decoded from the Embedded Media (steps 110-112 of FIG. 10).

Printed Media Implementation

FIG. 17 illustrates the steps of an implementation of the present invention in which a Covert Message is sent and received via printed media. In step 175, a Covert Message is embedded into Overt Media to generate Embedded Media (e.g. steps 102-105 of FIG. 10). In step 176, the Embedded Media is printed on a Distribution Medium, such as a ticket, poster, or t-shirt, and in step 177, the sender delivers, posts or distributes the Distribution Medium on which the Embedded Media is printed (e.g. step 106 of FIG. 10). In step 178, the receiver uses a Capture Device (e.g., smartphone/camera/scanner) to acquire an image including the Embedded Media from the Distribution Medium (step 108 of FIG. 10). The particular application of using a Capture Device to image the Embedded Media is described in more detail in FIG. 20. In step 179, the Covert Message is decoded from the Embedded Media (steps 110-112 of FIG. 10).

Electronic Media Implementation

FIG. 18 illustrates the steps of an implementation of the present invention in which a Covert Message is sent and received via electronic media such as television, electronic billboard, etc. In step 185, a Covert Message is embedded into Overt Media to generate Embedded Media (e.g. steps 102-105 of FIG. 10). In step 186, the sender sends or provides the Embedded Media to the target electronic Distribution Medium such as television or electronic billboard, and the Embedded Media is displayed on the electronic media (e.g. step 106 of FIG. 10). In step 187, the receiver uses a Capture Device to acquire an image including the Embedded Media from the electronic media (step 108 of FIG. 10; FIG. 20). In step 188, the Covert Message is decoded from the Embedded Media (steps 110-112 of FIG. 10).

Decode+Lookup Implementation

FIG. 19 illustrates the steps of an implementation of the present invention in which a received and decoded Covert Message is looked up to obtain further content. In step 195, a Covert Message is embedded into Overt Media to generate Embedded Media (e.g. steps 102-105 of FIG. 10). In step 196, the sender transmits the Embedded Media (e.g. step 106 of FIG. 10), and in step 197, the receiver receives the Embedded Media (step 108 of FIG. 10; FIG. 20). In step 198, the Covert Message is decoded from the Embedded Media (steps 110-112 of FIG. 10). In step 199, the Covert Message (code or data) is looked up in a Database or via the Internet to obtain further content associated with the Covert Message.

Reading Embedded Data from Printed/Electronic Media Using Capture Device

FIG. 20 illustrates the steps involved in reading Embedded Media from Printed or Electronic Media using a standard Capture Device such as a smartphone or camera, as is done for example in step 108 of Receive block 107 in some implementations of the present inventions. In step 200, the software is initialized, and in step 201, an image frame is captured with the Capture Device. In step 202, the captured image frame is checked or tested for Embedded Media. Details of the checking/testing step 202 are described below with reference to FIGS. 22-25. If Embedded Media is not found in the frame, the process returns to step 201 and a new image frame is captured.

If Embedded Media is found in the frame, the frame is prepared for decoding in step 203. Example procedures involved in preparing the frame for decoding in step 203 are illustrated in more detail in FIG. 25. Step 204 determines whether the frame is ready for decoding, in particular, whether the quality of the image is sufficient to extract the Covert Message (which may be based on the Covert Metadata). If the frame is not ready for decoding, the process returns, depending on the image quality, either to step 203 for further frame preparation or to step 201 to capture a new frame. In step 205, the Covert Message is decoded from the Embedded Media (steps 110-112 of FIG. 10), and in step 206, the Covert Message is extracted and interfaced with an end application.

Image Capture and Internet/Database Lookup

FIG. 21 illustrates steps involved in acquiring Embedded Media using a Capture Device and then retrieving additional content associated with the Covert Message decoded from the Embedded media from the Internet or a Database. In step 210, printed or electronic media is provided with Embedded Media as described, for example, in FIGS. 17 and 18. In step 211, an image including the Embedded Media is acquired using a Capture Device and decoded as described, for example, in FIG. 20. The Covert Message decoded from the Embedded Media is used as a code in step 212 to lookup/retrieve additional content associated with the code from a Database or the Internet. In step 213, the additional content is then used to interface with an end application or may be displayed to the user, for example, using a GUI (graphical user interface).

The dashed line in FIG. 21 from step 211 to step 213 indicates the process flow for applications in which no Internet/Database lookup is required. Here, the Covert Message acquired in step 211 is provided directly to the end application or GUI in step 213 without any lookup of the Covert Message in the Internet/Database.

Storing Features and Descriptors for Known Media

FIG. 22 addresses an implementation in which the set of Overt Media is known ahead of time, and the features and descriptors of the set of know Overt Media are prepared ahead of time and stored to be used later. FIG. 22 is used in conjunction with FIG. 23 (comparing media against known media), and together the process of FIGS. 22 and 23 may be used when checking/testing a captured image frame to determine whether it contains Embedded Media (e.g. step 202 of FIG. 20).

In step 220, the overt media(s) are loaded into the system. In step 221, a Feature Detector is used to extract the features of the media. In one implementation, for example, a Brisk Feature Detector is used. In step 222, a Descriptor Extractor is used to extract the descriptors from the media based on the Feature Detector output of step 221. In one implementation, for example, a Brisk Descriptor Extractor is used. In step 223, the extracted features and descriptors are stored for later use. In one implementation, the extracted features and descriptors are stored in an SQL Database.

Extract Covert Message from Known Overt Media

FIG. 23 describes the steps involved in decoding a Covert Message from known Overt Media that has had features and descriptors stored as described in FIG. 22. In step 230, the Embedded Media is loaded into the system, either directly from a file or via a Capture Device. In step 231, the features of the media are extracted using a Feature Detector such as a Brisk Feature Detector. In step 232, descriptors are extracted using a Descriptor Extractor such as a Brisk Descriptor Extractor. In step 233, the extracted features and descriptors are compared against a database of known features and descriptors, such as the SQL database of FIG. 22. In one implementation, step 233 is carried out using a Matcher such as a Hamming brute force Matcher. If a match exists, in step 234, Covert Metadata for the specific Overt Media is looked up and downloaded from the database. If required, in step 235, the Embedded Media is prepared for decoding (see FIG. 25). In step 236, the Covert Message is decoded from the Embedded Media (steps 110-112 of FIG. 10).

Extract Covert Message from Unknown Overt Media

FIG. 24 describes the steps involved in decoding a Covert Message from Overt Media that is not known, in other words, from Overt Media that has not had features and descriptors previously stored in a Database as described in FIG. 22. The process of FIG. 24 may be used when checking/testing a captured image frame to determine whether it contains Embedded Media (e.g. step 202 of FIG. 20).

In step 240, the Embedded Media is loaded into the system, either directly from a file or via a Capture Device. If required, in step 241, the Embedded Media is prepared for decoding (see FIG. 25). In step 242, the Covert Message is decoded from the Embedded Media (steps 110-112 of FIG. 10) using a default decoding method, since it is not yet known whether the Embedded Media contains Covert Metadata. In step 243, the system checks whether the decoded Covert Message contains Covert Metadata. If there is no additional Covert Metadata, then the decoded Covert Message extracted in step 243 is the final Covert Message and is usable by the end application or GUI, and the process finishes in step 245. However, if there is Covert Metadata present in the decoded Covert Message, then the decoded Covert Message is decoded again in step 244 based on the instructions in the Covert Metadata. The Covert Message extracted in step 244 is, in this case, the final Covert Message that is usable by the end application or GUI.

Preparation of Captured Image for Decoding

As mentioned in the various examples above, in certain cases a captured image requires additional preparation in order for it to be ready for decoding. FIG. 25 illustrates exemplary steps that can be used to prepare a captured image for decoding.

In step 250, the geometry of the image is corrected. In particular, if the image was captured using a Capture Device, it may be necessary to correct the geometry of the image. If a transform exists as an output from the Matcher, this transform can be used to warp the geometry of the image to a required form (see, e.g., step 233 of FIG. 23). If there is no transform from the Matcher, the Embedded Media must be extracted from the image. Depending on the type of image, the extents of the image can be determined using techniques such as edge detection to find the location of the Embedded Media within the image. Once the boundaries of the Embedded Media are found, a transform can be generated to warp the geometry of the image to a required form.

In step 251, the color/hue/saturation of the image is corrected. In particular, a number of color/hue/saturation methods can be applied to correct for lighting and image acquisition issues.

In step 252, the image is corrected for sharpness. The Capture Device will optimally have an autofocus feature, however, in some cases the image will need to be further enhanced using a number of standard filters.

Embed Covert Data in Overt Media Using Frequency Domain Encoding

FIG. 26 illustrates steps involved to embed Covert Data in Overt Media using a frequency domain encoding method. Steps 261, 263, and 264 of FIG. 26 are one implementation of step 105 from FIG. 10. In step 261, Overt Media 260 is transformed to the frequency domain. In one implementation, the entire Overt Media is transformed from time domain to frequency domain using a Fourier transformation. In step 263, Covert Data 262 is encoded into the frequency domain coefficients from the Fourier transformation. In one implementation, this is done by first ordering the coefficients based on their magnitude. The Covert Data is then encoded in the low order bits of a section of the ordered coefficients. In another implementation, smaller sections of the Overt Media are each transformed to the frequency domain using a Fourier transformation. In another implementation, instead of ordering the coefficients, a block of unsorted coefficients in the Fourier transformed image are encoded in the low order bits. In step 263, the Covert Data is broken up and encoded into different sections of the transformed media. A similar ordering of the coefficients is performed to select coefficients to encode the data. Once the embedding is completed the frequency domain image is transformed back to time domain (step 264) using a reverse Fourier transformation. In the implementation where smaller sections of the image were transformed and encoded individually, a reverse transformation is performed on each of the sections, and the sections are then copied back into the time domain image. FIGS. 28 and 29 show additional steps for encoding the data where Covert Metadata is being used. The encoding of the Covert Metadata itself follows the same method of encoding any other type of Covert Data.

Extract Covert Data from Overt Media Using Frequency Domain Encoding

FIG. 27 illustrates steps involved for extracting Covert Data from acquired Embedded Media. Steps 271 and 272 of FIG. 27 are one implementation of step 110 of FIG. 10. In one implementation, in step 271, the entire Embedded Media 270 is transformed from time domain to frequency domain using a Fourier transformation. The frequency domain coefficients are then ordered by magnitude and raw Covert Data 273 is extracted from the low order bits of a section of the coefficients in step 272. In another implementation, an unsorted block of the Fourier domain “image” is used to extract raw Covert Data. The raw Covert Data may still need additional processing steps (as in step 111 of FIG. 10), before it is ready to be read.

Encoding Covert Metadata

FIG. 28 illustrates steps involved in generating and encoding Covert Metadata in Overt Media. In step 281, based on Overt Media 280 and the Channel, the best place to encode the prepared Covert Data 282 is selected based on characteristics of the Overt Media. This step may be done manually or in an automated way. In one implementation, it was determined that the best place to encode the Covert Data was in the frequency domain, using a global Fourier transform, and to encode in the low order bits of a block of the Fourier “image”. This combination of choices constitutes the Covert Metadata of step 284. This Covert Metadata is used in step 283 to encode the Covert Data (as in FIG. 26). Once the Covert Data has been encoded the Overt Media and Channel are again examined in step 285 to determine the best place to encode the Covert Metadata of step 284. The default Covert Metadata encoding is determined a priori based on the application and can be a single default encoding method, or more than one than can be selected between. In one implementation it was determined that the best place to encode the Covert Metadata was in the frequency domain, using local Fourier transforms at several locations on the image, and then encoding the data in the low order bits of several of the Fourier transform coefficients. The Covert Metadata of step 284 is then encoded in step 286, and the result is Embedded Media 287.

Decoding Covert Metadata

FIG. 29 Illustrates the steps involved to decode Embedded Media 290 that contains Covert Metadata. In step 291, Embedded Media 290 is tested to determine if Covert Metadata exists in the media. If Covert Metadata does not exist, the media is decoded in step 294 based on a default set of decoding instructions or default Covert Metadata based on the application. If the Embedded Media does contain Covert Metadata, the Covert Metadata is read and decoding is based on the embedded Metadata instructions (step 293). Step 293 follows similar decoding methods as in the implementation described in FIG. 26.

The system and method of the present invention described herein may be implemented in any type of computer system or programming or processing environment including personal computing devices, smart-phones, pad computers, cameras, scanners, augmented reality systems and the like. The methods described herein may be implemented as instructions in software code or hardware and may be executed by any suitable microprocessor, central processing unit (CPU) or the like, and may be embodied in any form of computer program product, meaning any medium or memory such as RAM, ROM or the like, that is configured to store or transport computer readable code, or in which computer readable code may be embedded.

In one implementation the encoding software was running on a Window 7 laptop and developed using Microsoft Visual Studio 2010 .NET tools. In another implementation the encoding software and decoding software was running on a Windows 7 laptop using Mathworks' Matlab software (version R2010b). In one implementation the decoding software was running on a Motorola DROID4 smartphone running the Android operating system (version 4.0.4), and the app was developed using the Eclipse development tools. In one implementation, the OpenCV image processing software library was used to provide support for mathematical and image processing capabilities.

1. A method embodied in a computer-readable medium for embedding and retrieving covert data in overt media comprising:
preparing the covert data so that it can be embedded;
embedding the covert data into the overt media to generate embedded media;
transmitting the embedded media to a sender;
receiving the embedded media by a receiver;
decoding the covert data from the embedded media;
preparing the covert data so that it can be read.

2. The method of claim 1, wherein the step of preparing the covert data so that it can be embedded comprises compressing, encrypting, encoding and interleaving the covert data.

3. The method of claim 1, wherein the step of embedding the covert data comprises time domain embedding or frequency domain embedding.

4. The method of claim 1, wherein the step of transmitting the embedded media comprises posting the embedded media on a web site, emailing the embedded media or printing/applying the embedded media to a distribution medium.

5. The method of claim 1, wherein the step of receiving the embedded media comprises downloading the embedded media from a web site, receiving the embedded media via email or imaging the embedded media using a capture device.

6. The method of claim 1, wherein the step of decoding the covert data comprises time domain or frequency domain decoding.

7. The method of claim 1, wherein the step of preparing the covert data so that it can be read comprises de-interleaving, decoding, decrypting and decompressing the data.

8. The method of claim 1, further comprising looking up the covert data in a Database or via the Internet to obtain further content associated with the covert data.

9. A method for acquiring covert data from printed or electronic media using a capture device comprising:
capturing an image frame with the capture device;
checking the captured image frame for embedded media;
preparing the captured image frame for decoding if embedded media is found;
decoding the embedded media to obtain the covert data.

10. The method of claim 9, wherein the step of preparing the captured image frame comprises:
correcting the geometry of the image;
correcting the color/hue/saturation of the image; and
correcting the sharpness of the image.

11. The method of claim 9, wherein the step of checking the captured image frame for embedded media comprises:
extracting features of the embedded media using a feature detector;
extracting descriptors using a descriptor extractor; and
comparing the extracted features and descriptors against a database of known features and descriptors.

12. The method of claim 1 or 9, further comprising:
determining whether the decoded covert data contains covert metadata; and
if the decoded covert data contains covert metadata, decoding the embedded media again based on instructions contained in the covert metadata.
